(19) United States
(12) Patent Application Publication
(10) Pub. No.: US 2005/0273188 A1
(43) Pub. Date: Dec. 8, 2005

(54) Method and apparatus for improving characteristics of acoustic and vibration transducers

(76) Inventors: Andrzej Barwicz, Trois-Rivieres (CA); Roman Morawski, Trois-Rivieres (CA); Wieslaw Barwicz, Warsaw (PL)

Correspondence Address: Ralph A. Dowell of DOWELL & DOWELL P.C., 2111 Eisenhower Ave., Suite 406, Alexandria, VA, 22314, US

(21) Appl. No.: 11/071,584

(22) Filed: Mar. 4, 2005

Related U.S. Application Data
(63) Continuation of application No. PCT/CA03/01315, filed on Sep. 8, 2003.
(60) Provisional application No. 60/408,339, filed on Sep. 6, 2002.

(51) Int. Cl. G06F 17/00

(52) U.S. Cl. 700/94

(57) ABSTRACT

A method for improving characteristics of acoustic and vibration transducers, including integrated microphones and integrated transducers of vibrations, is disclosed. The method consists in the use of a low-fidelity acoustic or vibration transducer for converting an acoustic signal into an analog electrical signal, an analog-to-digital converter for converting the analog electrical signal into a digital signal and a digital processor for correcting and enhancing the latter signal. The resulting digital representation of the acoustic signal is analogous to that attainable by using a high-fidelity transducer.

### FIELD OF THE INVENTION

This invention relates generally to sound and vibration instrumentation, and more specifically to a method and apparatus for improving the fidelity of acoustic and vibration transducers.

### BACKGROUND OF THE INVENTION

Small high-fidelity microphones are highly advantageous as they combine portability with acoustic fidelity. For example, in environmental applications, there is a need for integrated and miniature microphones for use directly at sites where measurements of noise are important. These microphones are connected to wireless transmitters and may transmit continually data sensed and necessary for real-time monitoring. Of course, these same transducers are provided with a sufficient fidelity for a given application and within a range of frequencies that is applicable to that application. Typically, there is a tradeoff between sensitivity, frequency response, size and cost. Smaller and more sensitive microphones, having excellent fidelity, are typically the most costly.

Of course, these high-cost microphones have numerous applications including entertainment (e.g. wireless microphones for performers), news media (e.g. wireless microphones for reporters), industry (e.g. microphones for leak detection), testing (e.g. microphones for measurements), industrial monitoring, and diagnostics for health care.

Any acoustic or vibration transducer converts an acoustic signal, i.e. a pressure varying with time, into an electrical signal containing a significant portion of information on the acoustic signal. Various physical principles may be used for designing such a transducer. The current state of the art in acoustic transducer design includes a measuring condenser microphone (diameter—½″ or 1/4″), a low-cost electret microphone, and IEPE (Integrated Electronics Piezo Electric) vibration transducer. Each of these devices converts the acoustic signal in to an analogue electrical signal. In recent years the analogue signal has been converted to the digital domain for recordal, transmission and/or extraction of information. However, the results are dependant on the fidelity of the analogue signal that is available.

Many modern acoustic and vibration transducers, including microphones, are very sophisticated and guarantee excellent performance in a studio or laboratory environment, but their in situ and/or mass applications are only possible in exceptional circumstances, since they are rather expensive, and require relatively expensive equipment for further signal processing. In general, the fidelity of microphones is considered adequate for most studio and/or laboratory applications and, therefore, recent efforts in improving microphones have focused on improving their in situ usability.

The miniaturization of acoustic and vibration transducers is a necessary precondition for their mass in situ application; however, their size is limited by required precision and accuracy of acoustic signal conversion because of existing relations between acoustic properties of a transducer and its physical dimensions. In general, the fidelity of commonly manufactured transducers is proportional to their dimensions. This is a noted and important limitation for miniaturization of acoustic and vibration transducers, which heretofore could not be circumvented. Unfortunately, since high-fidelity transducers are often bulky and expensive, many known and important applications of such transducers remain unimplemented due to costs and/or inconvenience.

The existing acoustic and vibration transducers, which are adaptable to mass in situ applications, are typically large and expensive. The dimensions are, for example, very critical for sound intensity probes; and, therefore, prices may reach several thousands of US Dollars for a single transducer. The same applies to array microphones and transducers applied in acoustic holography.

Attempts to implement the functions of acoustic or vibration transducers using semiconductor-based integration technologies have resulted in lower quality of operation than that obtained by means of classic discrete technologies. If industrial applications of acoustic and vibration transducers are considered, the most desirable feature to be developed is miniaturization without a loss of fidelity or frequency range.

### OBJECT OF THE INVENTION

It is an object of this invention to provide a transducer and method for processing signals in which the above disadvantages are obviated or mitigated.

### SUMMARY OF THE INVENTION

According to the present invention there is provided A method of processing a input signal propogated as a disturbance in a transmission medium comprising the steps of:
a. applying said input signal to a transducing element to obtain an analogue signal corresponding thereto;
b. digitizing the resulting analogue electrical signal to provide a first set of data representative of said analogue signal; and
c. applying to said first set of data a signal reconstruction algorithm to provide a second set of data providing a higher fidelity representation of said input signal of than said first set of data.
   According also to the present invention there is provided a transducer comprising:
a. a transducing element for converting a time varying disturbance into an analog electrical signal;
b. an analog-to-digital converter for converting said analog electrical signal into a first set of data representative of the analog electrical signal; and
c. a digital signal processor for transforming said first digital signal into a second set of data, said second set of data being a representation of said time varying disturbance at a higher fidelity than said first set of data.

In practical; implementations, the method of processing the signal is generally more efficient than sophisticated analog processing and free of troubles characteristic thereof. It has significant advantages over mechanical processing and since most acoustic sensing systems are already coupled with digital processing circuitry, the added cost for the implementation is not substantial, though specialized processors may provide improved performance. Although acoustic and vibration transducers have seen few significant advances in past several decades, digital processors are experiencing significant performance gains so that with enhanced performance, more complicated and sophisticated methods may be implemented. This allows for improved performance and/or further miniaturization as processor technology improves. Furthermore, today's semiconductor-based integration technologies allow for VLSI implementation of digital processors and micro-mechanical components to allow for integrated microphone technology. Moreover, an increase in accuracy of electrical digital signal processing does not necessarily imply an increase in technological difficulties of its implementation, which is typical of mechanical signal processing.

Advantageously, in a preferred embodiment low-cost, low-fidelity micro-mechanical components may be used allowing the manufacture of a plurality of embodiments of miniature high-fidelity transducers and hand-held apparatuses containing them. The apparatuses include sound level meters and analyzers adapted to different needs. For example, some may be provided with wireless communication for near continuous transmission of information using wireless, or other communication systems. This is useful, in particular, for real-time industrial and environmental monitoring.

Embodiments of the present invention will now be described by way of example only with reference to the accompanying drawings, in which:

### BRIEF DESCRIPTIONS OF THE DRAWINGS

FIG. 1 shows a block diagram of an acoustical signal processing system,

FIG. 2 shows a block diagram of a transducer used in the system of FIG. 1,

FIG. 3 is a flow chart showing the processing of an acoustic signal by the system of FIG. 1, and

FIG. 4 is a block diagram, similar to FIG. 2 of an alternative embodiment of transducer.

### DETAILED DESCRIPTION OF THE INVENTION

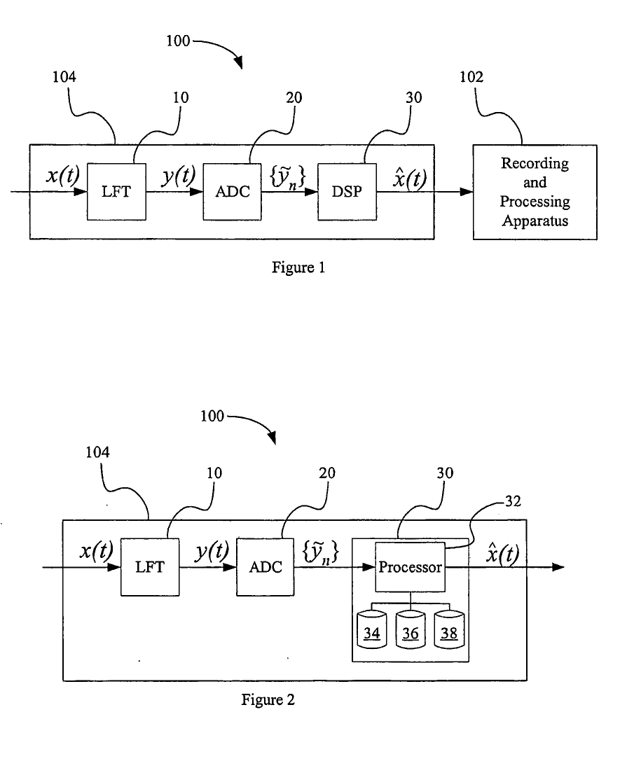

Referring initially to FIG. 1, a high-fidelity transducer (HFT) 100 receives an input signal from an external source and delivers it as a signal to a signal recording and processing apparatus 102. The apparatus 102 may be an information recordal system, or a communication system that permits further analysis of the signal received from the HFT 100. The input signal is in general a signal propagated as disturbances in a physical transmission medium, such a vibration, and for convenience of description it will be assumed that the signal is a vibration that provides an acoustic signal.

The HFT 100 is formed as an integrated structure on a printed circuit board 104 and comprises a low-fidelity transducer (LFT) 10, an analog-to-digital converter (ADC) 20, and a digital signal processor (DSP) 30. The LFT 10 is a transducer of suitable form factor to provide an analogue output signal representative of the acoustic signal received from the external source. Additional signal conditioning may be incorporated between the components, such as a filter, but these have not been shown for clarity.

The HFT 100 is formed as an integrated structure on a printed circuit board 104 and comprises a low-fidelity transducing element (LFT) 10, an analog-to-digital converter (ADC) 20, and a digital signal processor (DSP) 30. The LFT 10 is a transducing element, commonly referred to as a microphone, of suitable form factor to provide an analogue output signal representative of the acoustic signal received from the external source.

As may be seen in greater detail in FIG. 2, the DSP 30 includes a micro-processor 32, and an instruction set 34 to implement a set of program instructions in the micro processor 32 to reproduce a signal augmentation algorithm. The DSP 30 also includes signal sample memory 36 and an instrument characteristic data store 38 that stores a data set of the parameters of an operator that maps the received acoustic signal in to the space of the data.

Experimentation has shown that loss of information caused by poor characteristics of an acoustic or vibration transducer, such as, for example, LFT 10, may be partially compensated for by appropriate processing of its output signal y(t), the processing being based on an a priori identified mathematical model of the transducer. Since the fidelity limitations imposed by physical size of an acoustic or vibration transducer are well understood, it has been found experimentally that by characterizing a LFT 10 it is possible to define a transform R for transforming the LFT 10 data, y(t), into a more accurate, i.e. a higher-fidelity, representation of the sound, x(t), provided to the LFT 10 input.

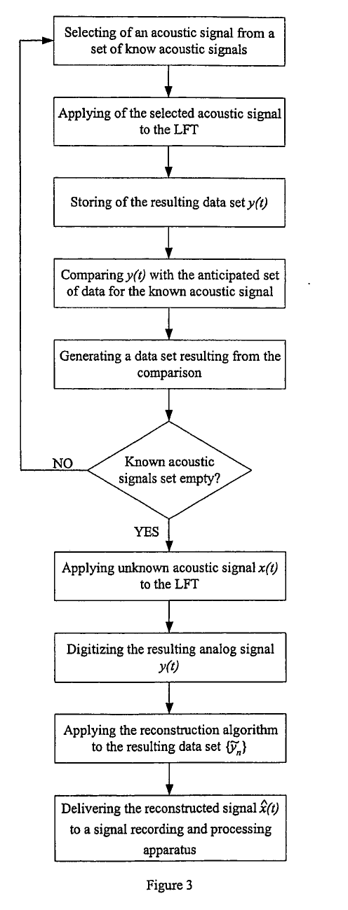

To facilitate the definition of the transform R, DSP 30 is provided, during a calibration process, with information on the metrological imperfections of LFT 10. In essence, as indicated in the calibration loop of FIG. 3, known acoustical signals are provided to the LFT 10 and the resultant signal y(t) analysed against known acoustical profiles for those signals. A set of calibration data resulting from the comparison of the electronic data and the known acoustical signal is determined and stored as a set of characteristic data in the data store 38 where it may be used during implementation of the signal augmentation algorithm in the processor 32.

In order to better understand the methods of acoustic signal reconstruction executed by DSP 30, the following notation is used:
t—time;
N—number of the data at the ADC 20 output;
Δt—step of time discretization;
{tₙ|n=1, . . . , N}—the sequence of time points, resulting from time dicretization; tₙ₊₁−tₙ=Δt;
{\tilde{y}ₙ}—the data representative of x(t) acquired at the ADC 20 output; \tilde{y}ₙ≅y(tₙ);
G—an operator (algorithm) of projection mapping the acoustic signal x(t) into the space of the data:
   {\tilde{y}ₙ}=G└x(t); P_{G}┘
where P_{G} is a vector or matrix of the parameters of the operator G, as stored as the data set 38 and determined during characterization of LFT 10; P_{G}=[P_{G,1} P_{G,2} . . . ]^{T} or:

$${p}_{G} = [ \begin{matrix}{p}_{G , 1 , 1} & {p}_{G , 1 , 2} & … \\ {p}_{G , 2 , 1} & {p}_{G , 2 , 2} & … \\ ⋮ & ⋮ & ⋰\end{matrix} ]$$
R—an operator of reconstruction, as implemented by the instruction set 34, such as a generalized deconvolution operator for transforming the data {\tilde{y}ₙ} into, an estimate \hat{x}(t) of x(t):
   \hat{x}(t)=R[{\tilde{y}ₙ}; P_{R}]
where P_{R}=[P_{R,1} P_{R,2} . . . ]^{T} are parameters of the operator R including regularization parameters derived from the parameters P_{G} determined during characterization of LFT 10.

The relationship between P_{G} and P_{R} will depend upon the nature of R and in some cases the parameters of R may be obtained directly from the calibration process.

The main objective of the method of enhancing the fidelity of LFT 10 is providing an estimate \hat{x}(t) of the acoustic signal x(t) on the basis of the acquired data {\tilde{y}ₙ}. The feasibility of this operation is critically conditioned by an auxiliary operation referred to as characterization (or calibration) of LFT 10. This operation is aimed at the acquisition of information on a mathematical model of a relationship between the data {\tilde{y}ₙ} and the acoustic signal x(t). Although calibration does not necessarily directly precede estimation of x(t) on the basis of the data {\tilde{y}ₙ} by the reconstruction algorithm, valid characterization results from the data set should be available during this process.

Referring therefore to FIG. 3, initially, one or more known acoustic signals are provided to the LFT 10 and the resulting data set y(t) stored. The known signals may be in the time and frequency domain and are chosen to provide sufficient information to determine the frequency domain transfer function. The DSP 30 processor 32 calls a comparison routine from the instruction set 34 and compares the actual data received with an anticipated set of data for that known set of signals. The processor 32 generates a data set based upon the comparison to provide the parameters PR and which are stored as the data set 38.

Subsequently, a signal is received at the LFT 10 which is processed by the ADC 20 to provide a set of data {\tilde{y}ₙ} to the DSP 30. The instruction set 34 is applied to the processor 32 to augment the data {\tilde{y}ₙ} using the reconstruction algorithm and data set 38 to output an augmented set of data \hat{x}(t) that is representative of the received signal x(t). The augmented signal \hat{x}(t) is then passed to the processing apparatus 102 where the augmented signal is utilised for further processing.

It will be observed that result of the processing of the apparatus 102 is no longer dependant on the fidelity of the LFT 10 as it is operating on an augmented signal, \hat{x}(t) rather than the relatively lower fidelity provided by the signal {\tilde{y}ₙ}. Consequently, a lower fidelity transducer may be utilised, providing either a decreased cost or decreased form factor to facilitate its deployment.

In the simplest case, the chosen operator of projection G for mapping the acoustic signal into the data space, is defined by the following operation:

$$\begin{matrix}y ( t ) = {\int }_{- ∞}^{+ ∞} g ( t - τ ) x ( τ ) ⅆ τ \\ {\hat{y}}_{n} ≅ y ( {t}_{n} ) for n = 1 , … , N\end{matrix}$$

where the function g(t) is the impulse response of the model of LFT 10.

Consequently, the vector of the parameters P_{G} of the operator G contains discrete values of this function or the parameters of a function used for its approximation (e.g. a linear combination of exponential functions).

The chosen operator of reconstruction R, for transforming the data {\tilde{y}ₙ} into an estimate \hat{x}(t) of x(t), may be obtained as a pseudoinverse of the operator G with respect to x(t). For example, it may be designed as: a rational filter described in M. Wisniewski, R. Z. Morawski, A. Barwicz: “Using Rational Filters for Digital Correction of a Spectrometric Microtrairsducer”, IEEE Trans. Instrum. & Meas., Vol. 49, No. 1, February 2000, pp. 43-48. or a spline-based Kalman filter described in M Ben Slima, R. Z. Morawski, A. Barwicz: “Kalman-filter-based Algorithms of Spectrophotometric Data Correction—Part II: Use of Splines for Approximation of Spectra”, IEEE Trans. Instrum. & Meas., June 1997, Vol. 46, No. 3, pp. 685-689. In the first case, the vector P_{R}=[P_{R,1} P_{R,2} . . . ]^{T} of parameters of the operator R contains coefficients of the rational filter; in the second case—discrete values of the function g(t) and regularization parameters for the spline-based Kalman filter.

Many variations of operators and mathematical models or algorithms may be implemented in the DSP 30 to obtain an augmented signal. For example, the following mathematical models of the data at the ADC 20 output may be used for defining the operator G:
the stationary linear model:

$$y ( t ) = {\int }_{- ∞}^{+ ∞} g ( t - τ ) x ( τ ) ⅆ τ$$
the non-stationary linear model:

$$y ( t ) = {\int }_{- ∞}^{+ ∞} g ( t , τ ) x ( τ ) ⅆ τ$$
the stationary non-linear model, e.g.:

$$\begin{matrix}y ( t ) = {\int }_{- ∞}^{+ ∞} g ( t - τ ) {F}_{x} [ x ( τ ) ] ⅆ τ , \\ y ( t ) = {F}_{y} [ {\int }_{- ∞}^{+ ∞} g ( t - τ ) x ( τ ) ⅆ τ ] or \\ y ( t ) = {F}_{y} [ {\int }_{- ∞}^{+ ∞} g ( t - τ ) {F}_{x} [ x ( τ ) ] ⅆ τ ]\end{matrix}$$
the non-stationary non-linear model, e.g.:

$$\begin{matrix}y ( t ) = {\int }_{- ∞}^{+ ∞} g ( t , τ ) {F}_{x} [ x ( τ ) ] ⅆ τ , \\ y ( t ) = {F}_{y} [ {\int }_{- ∞}^{+ ∞} g ( t , τ ) x ( τ ) ⅆ τ ] or \\ y ( t ) = {F}_{y} [ {\int }_{- ∞}^{+ ∞} g ( t , τ ) {F}_{x} [ x ( τ ) ] ⅆ τ ]\end{matrix}$$
where g(t) and g(t,r) are the impulse responses of LFT 10; Fₓ and F_{y} are non-linear functions.

The following methods of signal reconstruction in the form of deconvolution or generalized deconvolution may be used for defining the operator R:
the original domain, numerical differentiation-based method as described in R. Z. Morawski, P. Sokolowski: “Application of Numerical Differentiation for Measurand Reconstruction”, Proc. 7th IMEK0-TC4 Int: Symp. Modern Electrical & Magnetic Measurements (Prague, CSSR, Sep. 13-14, 1995), pp. 230-234.;
the iterative methods of Jansson and Gold;
the spectrum-domain, Tikhonov-regularization-based method;
the cepstrum-domain, Tikhonov-regularization-based method;
the original-domain, Tikhonov-regularization-based method with the positivity constraint imposed on the solution;
the Kalman-filter-based method with the positivity constraint imposed on the solution;
the Kalman-filter-based method with spline-approximation of the solution;
the adjoint-operator method as described in R. Z. MORAWSKI, B. Pawiński: “Improving Resolution of Spectrometric Analysis by Means of Adjoint-operator Method and B-splines”, Proc. 6th Int. Conf. Industrial Metrology CIMI'95 (Zaragoza, Spain, Oct. 25-27, 1995), pp. 382-390.;
the entropy-based variational method;
the Volterra-series-based methods;
the rational-filter-based method as described in M. Wiśniewski, R. Z. Morawski, A. Barwicz: “Using Rational Filters for Digital Correction of a Spectronletric Microtransducer”, IEEE Trans. Instrum. & Meas., Vol. 49, No. 1, February 2000, pp. 43-48.

Moreover, many other methods developed in the domain of chemometrics, telecommunications, seismology and image processing may also be used to provide to obtain the benefits inherent in those techniques.

To determine the parameters of the operator R
a direct transformation of the parameters of the operator G may be used;

To obtain the operator R directly it is possible to use:—
the minimization of any norm of the solution ∥P_{R}∥ under constraints imposed on another norm of the discrepancy ∥x^{cal}(t)−R[{\tilde{y}ₙ^{cal}}; P_{R}]|; where x^{cal}(t) and {\tilde{y}ₙ^{cal}} are reference signal and data, respectively;
the minimization of any norm of the discrepancy |x^{cal}(t)−R [{\tilde{y}ₙ^{cal}}; P_{R}]| under constraints imposed on another norm of the solution |P_{R}|; where x^{cal}(t) and {\tilde{y}ₙ^{cal}} are reference signal and data, respectively.

Fusion of the functional blocks LFT 10, ADC 20, and DSP 30 enables a designer of the HFT 100 to profit from advantages of both mechanical and electrical methods of signal processing. In fact, reprogramming of the instruction set 34 of the processor 32 in the HFT 100 is possible and software modifications that improve the overall performance are anticipated. It is well known that software distribution and upgrading is inexpensive relative to the costs associated with similar hardware upgrades.

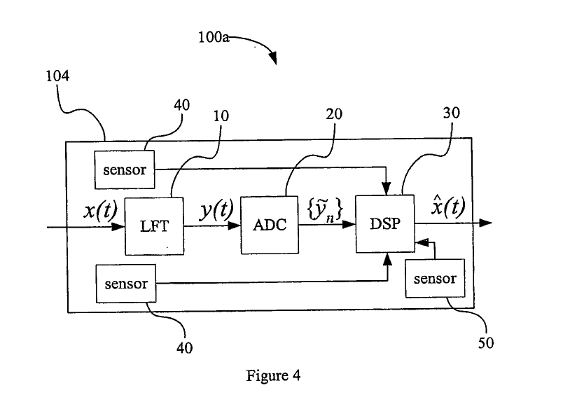

The use of an integrated device provides excellent opportunity for automatic correction of temperature-induced errors which are common in industrial applications. FIG. 4, in which like components will be denoted with like reference numerals with a suffix “a” added for clarity, shows a block diagram of a HFT 100a in which a small temperature sensor circuit 40 is disposed in at least one location within the integrated device. The temperatures are determined and provided to the DSP 30 and appropriate correction of the LTF 10 output signal is performed depending on those temperatures by providing, within transform R, for errors induced by temperature fluctuations. Of course, DSP 30 is not susceptible to errors induced by temperature fluctuations so long as it operates within a suitable temperature range. Therefore, the EFT 100a is provided with an effective low-cost system of compensating for temperature fluctuations. The HFT 100a may also be provided with one or more additional sensors 50 for sensing other quantities capable of inducing errors within the LFT 10 output data y(t).

Although the present invention has been described with respect to specific embodiments thereof, various changes and modifications are optionally carried out by those skilled in the art without departing from the scope of the invention. Therefore, it is intended that the present invention encompass such changes and modifications as fall within the scope of the appended claims.

1. A method of processing a input signal propagated as a disturbance in a transmission medium comprising the steps of
a. applying said input signal to a transducing element to obtain an analogue signal corresponding thereto;
b. digitizing the resulting analogue electrical signal to provide a first set of data representative of said analogue signal; and
c. applying to said first set of data a signal reconstruction algorithm to provide a second set of data providing a higher fidelity representation of said input signal of than said first set of data.

2. A method according to claim 1 further comprising the steps of:
a′. applying to said transducing element a first test signal of known characteristic and obtaining a first data sequence representative of said first test signal;
b′. comparing said first data sequence image to a second data sequence being a precise representation of said first test signal, and
c′. utilising said comparison to obtain calibration data for application by said signal reconstruction algorithm.

3. A method according to claim 2 wherein a plurality of test signals are applied to said transducing element to generate said calibration data.

4. A method according to claim 1 wherein temperature of said transducing element is monitored and applied to said signal reconstruction algorithm.

5. A method according to claim 2 wherein said calibration data is utilized to determine parameters of an operator mapping said input signal to said data set.

6. A method according to claim 5 wherein said calibration data is utilized to determine an operator of reconstruction to be applied by said reconstruction algorithm.

7. A method according to claim 1 wherein said input signal is a vibration.

8. A method according to claim 7 wherein said vibration is an acoustic signal.

9. A transducer comprising:
a. a transducing element for converting a time varying disturbance into an analog electrical signal;
b. an analog-to-digital converter for converting said analog electrical signal into a first set of data representative of the analog electrical signal; and
c. a digital signal processor for transforming said first digital signal into a second set of data, said second set of data being a representation of said time varying disturbance at a higher fidelity than said first set of data.

10. A transducer according to claim 8 wherein said digital signal processor includes a set of calibration data and an instruction set to implement a signal augmentation algorithm.

11. A transducer according to claim 8 wherein said transducing element is a microphone.

12. A transducer according to 8 wherein said transducing element, analogue to digital converter and digital signal processor are integrally formed on a common support structure.

13. A transducer according to claim 8 further comprising at least one sensor for sensing a parameter capable of inducing errors within said transducing element, said sensor being connected to said digital signal processor to permit compensation for changes in said parameter.

14. A transducer according to claim 11 wherein at least one of the sensors is a temperature sensor for measuring temperature fluctuations of said transducing element.
